(19) United States
(12) Patent Application Publication
(10) Pub. No.: US 2011/0080335 A1
(43) Pub. Date: Apr. 7, 2011

(54) BEDROOM PROJECTOR WITH CLOCK AND AMBIENT LIGHT CONTROL FEATURES

(75) Inventors: ROBERT ALLAN UNGER, El Cajon, CA (US); Robert Hardacker, Escondido, CA (US); Christopher Jensen Read, San Diego, CA (US)

(73) Assignees: SONY CORPORATION; SONY ELECTRONICS INC.

(21) Appl. No.: 12/573,494

(22) Filed: Oct. 5, 2009

(51) Int. Cl. G06F 3/02

(52) U.S. Cl. 345/156

(57) ABSTRACT

The brightness of a bed-mounted projector that projects images on a wall or ceiling is established in proportion to the ambient light level in the room. A motion detector can be used to operate room lights in the room only at user-defined times. Keystone correction of the image can be made based on the projection angle as sensed by an orientation sensor. An input strip on the headboard centerline can be used as a control input device.

### I. FIELD OF THE INVENTION

The present invention relates generally to bedroom projectors with control features based on a clock and ambient light sensors.

### II. BACKGROUND OF THE INVENTION

Home networks have been provided to distribute video and other entertainment throughout a home. As understood herein, projectors may be provided in home networks to conveniently present images on various surfaces of the home. As further understood herein, such networks' may be leveraged to not only distribute images and other entertainment but also to provide the user with an integrated, intuitive means for controlling ancillary home components that might tangentially relate to image display and/or otherwise be controllable in concert with entertainment presentation.

### SUMMARY OF THE INVENTION

A system includes a bed-mounted projector, a processor controlling the projector, and an orientation sensor outputting a signal indicating an orientation of projection of the projector. The processor uses the signal to establish keystoning in an image projected by the projector.

In some embodiments the orientation sensor includes a MEMS device. A projection axis of the projector can be movable responsive to control by the processor. If desired, a user input device may be mounted along a centerline of the bed, and a feedback image of the input device can be included in images projected by the projector. In examples, the input device is manipulable to cause the processor control a lamp in a room in which the bed is disposed. Also, in some examples a brightness used by the projector in projecting an image is adjusted based on ambient light level in a room in which the bed is disposed. The user may be permitted to enable and disable ambient light level adjustment of the brightness.

In example embodiments the processor can receive input from a motion detector and control a lamp based thereon. A user may be permitted to define a period when input from the motion detector is not used to control the lamp and a period when input from the motion detector is used to control the lamp.

In another aspect, an apparatus includes a projector, a processor controlling the projector, and an ambient light detector providing input to the processor indicating an ambient light level in a room in which the projector is disposed. A brightness used by the projector in projecting an image is established based on the input.

In another aspect, an assembly includes a projector, a processor controlling the projector, and a motion detector. The processor receives input from the motion detector and controls a lamp based thereon. A user can define at least one period when input from the motion detector is not used to control the lamp and at least one period when input from the motion detector is used to control the lamp.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example system in accordance with present principles;

FIG. 2 is a flow chart of example logic;

FIG. 3 is a screen shot of an example top level menu display; and

FIGS. 4-8 are screen shots of example second level menu displays.

### DETAILED DESCRIPTION OF THE PREFERRED EMBODIMENT

Referring initially to FIG. 1, a system 10 includes a projector 12 that may be mounted on a bed 14 having a headboard 16. The projector 12 may be a 60 GHz projector or other projection device that can project images onto a ceiling 18 of the bedroom or a wall 20 of the bedroom.

The projector 12 may be fixedly or movably mounted on the frame of the bed 14. An orientation sensor 22 such as but not limited a micro electromechanical system (MEMS) device can be used to sense the orientation of the projector 12 and more specifically the orientation of the projection axis of the projector 12. To this end, gyros, accelerometers, and other MEMS components may be coupled to the projector 12 as appropriate to sense the projection axis. When the projector is movably mounted on the bed frame it may be mounted on a pivot to permit it to be turned in azimuth as well as in elevation. The projector may be movably mounted for adjusting its projection axis by hand or it may be moved by a motor controlled by the processor discussed below.

In other embodiments discussed below, the projector 12 may be fixedly mounted on the bed frame, and a mirror-based MEMS device can be used to direct the projection beam on a surface as desired by the user.

In any case, the sensor 22 may communicate with a processor 24 over a wired or wireless link, and the components shown in FIG. 1 may communicate over a home network. The projector 12, processor 24, and orientation sensor 22 may be housed together in a single chassis if desired. The processor 24 can also communicate with the projector 12 for sending still and moving video images thereto from an appropriate source such as but not limited to a computer-readable medium 26 such as a hard disk drive or solid state storage, a video disk player 28, a TV 30, and a network interface 32 which communicates with the Internet 34 to receive images therefrom.

For purposes to be shortly disclosed, the processor 24 may receive input from an ambient light sensor 36 which generates a signal representing the level of lighting in the bedroom, a motion sensor 38 that produces a signal indicating whether any motion is occurring in the room, and a clock 40. The processor 24 may further receive input from a user input device 42 such as touch-sensitive strip that may be centrally mounted on the axis of the headboard 16 so that a person on either side of the bed can easily touch the input device 42. As discussed below the processor 24 may communicate with one or more lamps 44 in the bedroom to establish a level of lighting in the bedroom.

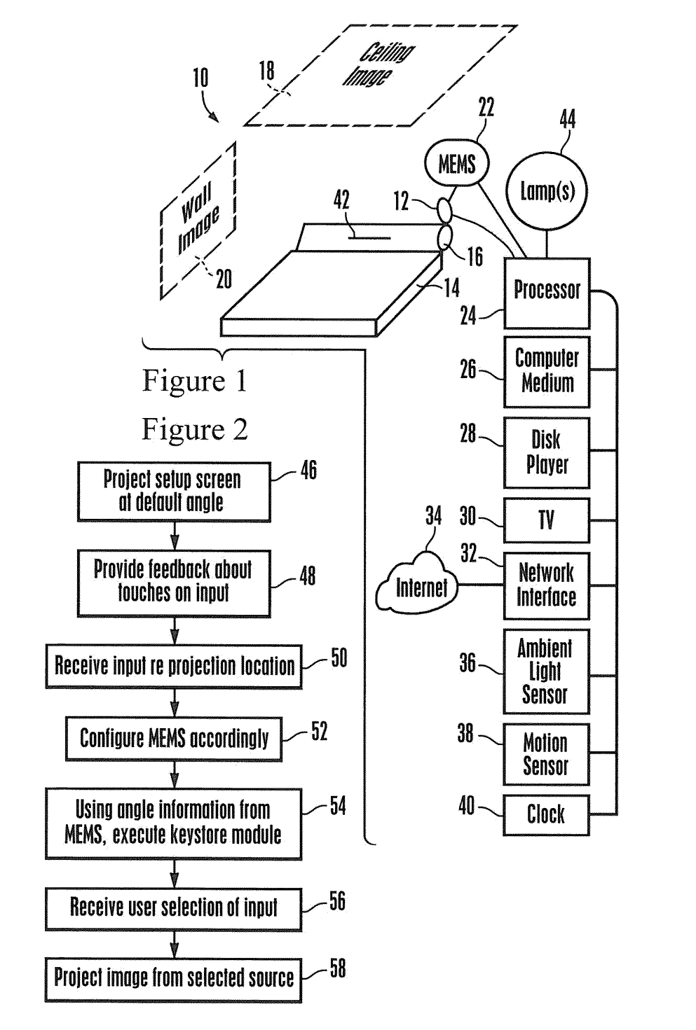

FIG. 2 shows logic that may be stored on the medium 26 for execution by the processor 24. Example embodiments may use all of the logic shown in FIG. 2 or only portions of it.

Commencing at block 46, a setup screen discussed further below, is projected onto a default surface, i.e., at a default angle. In implementations in which the projector (and projection axis) is fixed this default angle may be vertical, i.e., onto the ceiling 18 above the bed. The default angle likewise may be vertical when the projector is movably mounted on the bed frame.

At block 48, as discussed below visual feedback of the input device 42 may be provided in the projected image. Signals from the input device 42 may be received at block 50, and when the projector 12 is motor-driven and/or when MEMS mirrors are used to establish the axis of projection the input signals may represent a desired projection angle (i.e., wall surface) on which to project the image.

When mirrors are used to redirect an otherwise fixed projection axis to a user-designated orientation, the logic may move to block 52 to configure the redirection mirrors accordingly. In any case, whether fixed or user-defined, the actual orientation of the projection axis as sensed by the orientation sensor 22 is received and used at block 54 to execute a keystone module that may be stored on the medium 26. The keystone module uses principles known in the art to account for projection angles that might otherwise result in image distortion. For example, when the projection angle is directly vertical no keystone correction may be needed, but when the projection angle is such that the image is projected onto a wall 20 as shown in FIG. 1, keystone correction of the projected image may be implemented to eliminate or reduce distortion in the image.

At block 56, from time to time the user may invoke the below-described source selection menu to select a source for projected images and this selection is received and used at block 58 to project an image from the selected source onto the ceiling or wall of the bedroom. FIG. 3 shows an example top level menu 60 that lists various features a user may select using the input device 42. The menu 60 may include an image 62 of the input device 42 providing a visual indication as to what various touches mean. In the example shown in FIG. 3 the image 42 indicates that a touch on the right part of the input device 42 indicates a down cursor input, a touch on the left side indicates up cursor, and a touch in the middle indicates “select”.

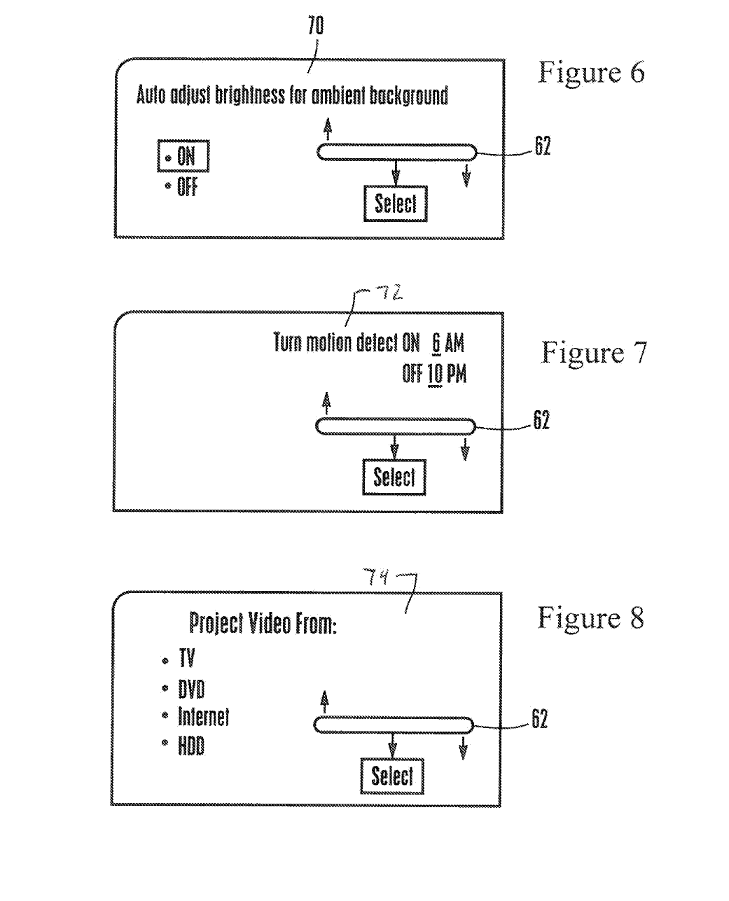

Among the example non-limiting features shown in FIG. 3 are “select projector surface” for movable projector embodiments in which the user can define the projection axis. For illustration, FIG. 3 shows by the box 64 that this is the selection on which the cursor currently is. Other example features may include “control room lighting” to cause the menu of FIG. 5 to appear, “enable auto projection power” to cause the menu of FIG. 6 to appear, “set motion detector sleep time(s)” to cause the menu of FIG. 7 to appear, and “select input source for image” to cause the menu of FIG. 8 to appear. The example features and method for navigating and selecting the features are not limiting but are for illustration only.

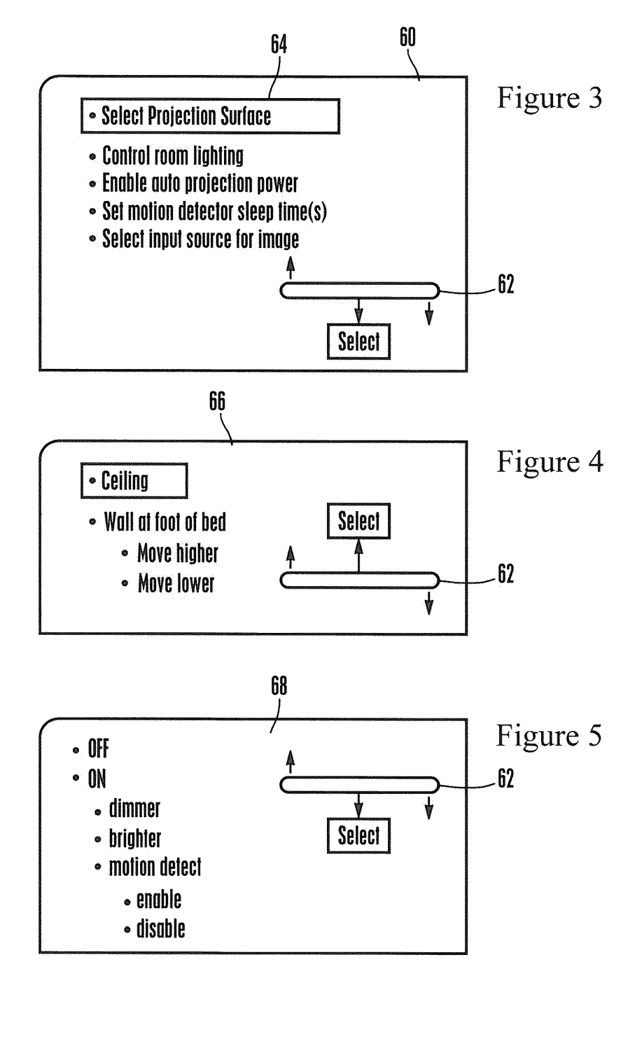

In embodiments in which the user is enabled to cause the processor 24 to alter the projection axis either by controlling a motor coupled to the projector 12 to move the projector or by controlling a mirror system to reflect the projected signal, a user can select from FIG. 3 “select projection surface” to cause the menu 66 of FIG. 4 to appear. As shown in FIG. 4 the user may select “ceiling” or “wall” and, if the latter, may be given the further opportunity to establish the elevation of projection axis centerline to be at the foot of the bed and to incrementally move the axis higher or lower by appropriately manipulating the input device 42, the projected image 62 of which presents intuitive visual feedback for navigating the menu 66.

FIG. 5 shows that the processor 24 can be caused to control the lamp 44 when the “control room lighting” selection of FIG. 3 is invoked. As shown the menu 68 in FIG. 5 presents the image 62 of the user input device 42 to give the user visual feedback. The input device 42 can be manipulated to turn the lamp 44 off or on and when on, to incrementally cause the lamp to be dimmer or brighter. Motion detection of lamp 44 energization may also be enabled or disabled as shown. When enabled, if the lamp 44 is off and motion is detected by the motion sensor 38 the lamp 44 is turned on (at the last-selected brightness level) by the processor 24. Similarly, if the lamp is on and no motion is detected for a predetermined period the lamp is turned off, when motion detection is enabled using the menu 68.

The submenu 70 of FIG. 6 can be presented by the projector when it is invoked from the main menu of FIG. 3 to enable or disable (using the input device 42 as indicated by the visual feedback image 62) automatic adjustment of the brightness of the image projected from the projector 12 based on the level of ambient light sensed by the ambient light sensor 36. When enabled, the brightness of the projected image is increased for higher levels of ambient light and lowered for lower levels of ambient light in the bedroom.

When motion detection control of the lamp 44 is invoked, the submenu 72 of FIG. 7 may be presented. The user input device 42 may manipulated as indicated in the visual feedback image 62 to set motion detection enable and disable times so that, for instance, the lamp will not be activated between the “OFF” and “ON” times selected by the user even if motion is detected when, for example, a person tosses and turns in bed. Motion detector-based lamp activation is enabled from the “ON” time to the “OFF” time input by the user.

A source selection menu 72 in FIG. 8 is presented when invoked from the main menu of FIG. 3 to enable the user to select the source for the projected image.

The clock 40, which may be a visible electronic clock controlled by the processor 24, may be reset by the processor 24 from time to time by causing the processor 24 to determine its location or time zone by pinging a timer server on the Internet. The local clock 40 can maintain the time even if network connectivity is lost. In this way the user need not ever have to adjust the time of the clock.

While the particular BEDROOM PROJECTOR WITH CLOCK AND AMBIENT LIGHT CONTROL FEATURES is herein shown and described in detail, it is to be understood that the subject matter which is encompassed by the present invention is limited only by the claims.

What is claimed is:

1. System comprising:
a bed-mounted projector;
a processor controlling the projector; and
an orientation sensor outputting a signal indicating an orientation of projection of the projector, the processor using the signal to establish keystoning in an image projected by the projector.

2. The system of claim 1, wherein the orientation sensor includes a MEMS device.

3. The system of claim 1, wherein a projection axis of the projector is movable responsive to control by the processor.

4. The system of claim 1, comprising a user input device mounted on a bed associated with the projector, a feedback image of the input device being included in at least some images projected by the projector.

5. The system of claim 4, wherein the input device is mounted along a centerline of the bed.

6. The system of claim 4, wherein the input device is manipulable to cause the processor control at least one lamp in a room in which the bed is disposed.

7. The system of claim 4, wherein a brightness used by the projector in projecting an image is adjusted based on ambient light level in a room in which the bed is disposed.

8. The system of claim 7, wherein the user can enable and disable ambient light level adjustment of the brightness.

9. The system of claim 1, wherein the processor receives input from a motion detector and controls a lamp based thereon.

10. The system of claim 9, wherein a user can define at least one period when input from the motion detector is not used to control the lamp and at least one period when input from the motion detector is used to control the lamp.

11. Apparatus comprising:
a projector;
a processor controlling the projector; and
an ambient light detector providing input to the processor indicating an ambient light level in a room in which the projector is disposed, wherein a brightness used by the projector in projecting an image is established based on the input.

12. The apparatus of claim 11, further comprising an orientation sensor outputting a signal indicating an orientation of projection of the projector, the processor using the signal to establish keystoning in an image projected by the projector.

13. The apparatus of claim 11, wherein a projection axis of the projector is movable responsive to control by the processor.

14. The apparatus of claim 11, comprising a user input device mounted on a bed associated with the projector, a feedback image of the input device being included in at least some images projected by the projector.

15. The apparatus of claim 14, wherein the input device is manipulable to cause the processor control at least one lamp in a room in which the bed is disposed.

16. The apparatus of claim 11, wherein the user can enable and disable ambient light level adjustment of the brightness.

17. The apparatus of claim 11, wherein the processor receives input from a motion detector and controls a lamp based thereon, wherein a user can define at least one period when input from the motion detector is not used to control the lamp and at least one period when input from the motion detector is used to control the lamp.

18. Assembly comprising:
a projector;
a processor controlling the projector; and
a motion detector, wherein the processor receives input from the motion detector and controls a lamp based thereon, wherein a user can define at least one period when input from the motion detector is not used to control the lamp and at least one period when input from the motion detector is used to control the lamp.

19. The assembly of claim 18, further comprising an ambient light detector providing input to the processor indicating an ambient light level in a room in which the projector is disposed, wherein a brightness used by the projector in projecting an image is established based on the input.

20. The assembly of claim 18, further comprising an orientation sensor outputting a signal indicating an orientation of projection of the projector, the processor using the signal to establish keystoning in an image projected by the projector.

21. The assembly of claim 18, comprising a user input device mounted on a bed associated with the projector, a feedback image of the input device being included in at least some images projected by the projector.
